(19) United States
(12) Patent Application Publication
(10) Pub. No.: US 2015/0002666 A1
(43) Pub. Date: Jan. 1, 2015

(54) APPARATUS FOR MONITORING AN IMAGE WITH LOW POWER

(71) Applicant: CENTER FOR INTEGRATED SMART SENSORS FOUNDATION, Daejeon (KR)

(72) Inventors: Jin Young YANG, Seoul (KR); Chai Yeol RIM, Seoul (KR); Chong Min KYUNG, Daejeon (KR); Jong Pil JUNG, Daejeon (KR)

(21) Appl. No.: 14/316,690

(22) Filed: Jun. 26, 2014

(30) Foreign Application Priority Data
Jun. 27, 2013 (KR) 10-2013-0074439
Mar. 13, 2014 (KR) 10-2014-0029601

(51) Int. Cl. H04N 19/156; H04N 7/18

(52) U.S. Cl. CPC H04N 19/00206; H04N 7/183
USPC 348/143

(57) ABSTRACT

Disclosed herein is an apparatus for monitoring an image with low power including: an image sensor unit; a low compression unit encoding image data acquired by the image sensor unit with a first compression rate; an event sensor unit generating an event signal when an event is sensed; a high compression unit operated by receiving the event signal and encoding the image data of the image sensor unit and the low compression unit with a second compression rate higher than the first compression rate; and a memory unit storing the image data encoded by the low compression unit and the high compression unit.

### CROSS REFERENCE TO RELATED APPLICATION

This application claims the benefit of Korean Patent Application No. 10-2013-0074439, filed on Jun. 27, 2013, entitled “APPARATUS FOR MONITORING AN IMAGE WITH LOW POWER”, and Korean Patent Application No. 10-2014-0029601, filed on Mar. 13, 2014, entitled “Camera Image Storing Apparatus for Reducing Power Consumption” which are hereby incorporated by reference in its entirety into this application.

### BACKGROUND OF THE INVENTION

1. Technical Field

The present invention relates to an apparatus for monitoring an image with low power, and more particularly, to an apparatus for monitoring an image with low power capable of reducing power consumption by compressing and storing an event image before and after a generation of an event with low power.

2. Description of the Related Art

An apparatus for monitoring an image is an apparatus which monitors a specific area by mounting a fixed or mobile camera at a specific place and processing image data input through the camera to recognize an object. The apparatus for monitoring an image may be classified into an apparatus for storing an image at all times and an apparatus for storing an image based on an event.

CCTV which is one of the apparatuses for monitoring an image at all times stores image data obtained in consideration of a capacity of a storage device with high compression such as H. 264. The high compression method consumes a considerable amount of power, but when a fixed power apparatus (charger and the like which is continuously charged by a power line or a power generator) is provided, a considerable amount of power consumption is out of the question and when a limited capacity of the storage device is considered, it is more preferable to use high compression than to use low compression having a low compression rate.

An apparatus for monitoring an image based on an event stores the image data when the specific event is generated and may be installed at a place at which fixing power is not supplied and therefore is mainly supplied with power by a battery. The apparatus for monitoring an image based on an event is operated in a low power state before the specific event is generated and then when an event is generated, stores the image in a non-volatile memory with high compression which consumes much power or wirelessly transmits the image to a server. In the case of using the apparatus for monitoring an image based on an event, image photographing does not start until the event is sensed. Therefore, it is impossible to obtain the image data before the occurrence of the event. However, to determine the exact situation at the time of the generation of the event, the image data are required before and after the occurrence of the event.

The typical apparatus for monitoring an image is disclosed in Patent Document 1. As illustrated in FIG. 1, the apparatus for monitoring an image is configured to include: an image sensor unit 1; an acoustic sensor unit 2; a filter unit 3 from which an image output from the image sensor unit 1 and the acoustic sensor unit 2 and noise included in the acoustic data are removed; a compression processing unit 4 which compresses and converts the image and the acoustic data output through the filter unit 3; and a storage unit 5 which sequentially stores the compressed image and acoustic data output through the compression processing unit 4 into a predetermined address. The typical apparatus for monitoring an image may very accurately and easily understand recording later by storing situations for a predetermined time before and after the occurrence of the event as the image and the acoustic data and comprehensively storing the event situations. However, the typical apparatus for monitoring an image repeats an operation of erasing the stored data and again storing new data with high compression, when the event is not occurred. In this case, unnecessary power consumption may be increased with the use of the high compression.

### RELATED DOCUMENT

### Patent Document

(Patent Document 1) KR 20-0279994 Y1 (Jul. 2, 2002)

### SUMMARY OF THE INVENTION

An object of the present invention is to provide an apparatus for monitoring an image with low power capable of acquiring image data before and after an occurrence of an event and acquiring image data while being operated in a state of low power consumption before the occurrence of the event to reduce unnecessary power consumption.

According to an exemplary embodiment of the present invention, there is provided an apparatus for monitoring an image with low power including: an image sensor unit; a low compression unit encoding image data acquired by the image sensor unit with a first compression rate; an event sensor unit generating an event signal when an event is sensed; a high compression unit operated by receiving the event signal and encoding the image data of the image sensor unit and the low compression unit with a second compression rate higher than the first compression rate; and a memory unit storing the image data encoded by the low compression unit and the high compression unit.

### BRIEF DESCRIPTION OF THE DRAWINGS

FIG. 1 is a block diagram illustrating an apparatus for monitoring an image according to the related art.

FIG. 2 is a diagram illustrating an apparatus for monitoring an image with low power according to a first exemplary embodiment of the present invention.

FIG. 3 is a block diagram illustrating a state in which a switch unit is connected to a high compression unit after sensing of an event, in the apparatus for monitoring an image with low power according to the first exemplary embodiment of the present invention.

FIG. 4 is a block diagram illustrating a state in which the switch unit connects a low compression unit to the high compression unit after the sensing of the event, in the apparatus for monitoring an image with low power according to the first exemplary embodiment of the present invention.

FIG. 5 is a signal diagram illustrating a switching process of the switch unit, in the apparatus for monitoring an image with low power according to the first exemplary embodiment of the present invention.

FIG. 6 is a configuration diagram illustrating a logical configuration of a first memory according to an exemplary embodiment of the present invention.

FIG. 7 is a flow chart illustrating an operating process of the apparatus for monitoring an image with low power according to the first exemplary embodiment of the present invention.

FIG. 8 is a diagram illustrating an apparatus for monitoring an image with low power according to a second exemplary embodiment of the present invention.

FIG. 9 is a reference diagram for describing a low power mode of the apparatus for monitoring an image with low power according to the second exemplary embodiment of the present invention.

FIG. 10 is a relationship diagram between the apparatus for monitoring an image with low power according to a second exemplary embodiment of the present invention and before and after an occurrence of an event.

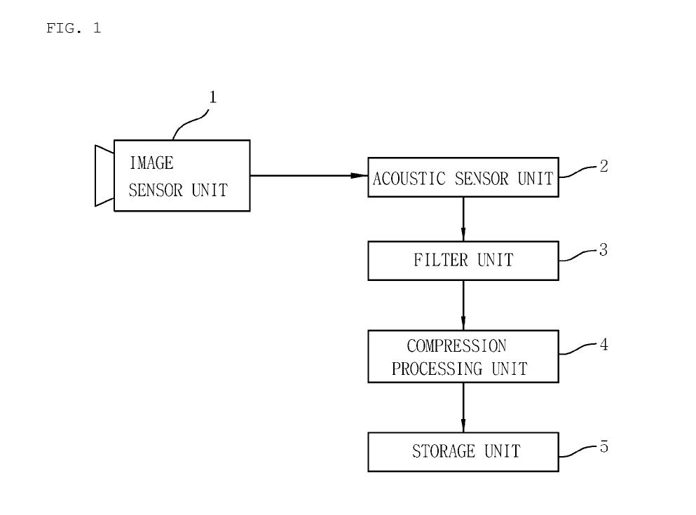

### DESCRIPTION OF THE EXEMPLARY EMBODIMENTS

Hereinafter, an apparatus for monitoring an image with low power according to an exemplary embodiment of the present invention will be described in detail with reference to the accompanying drawings.

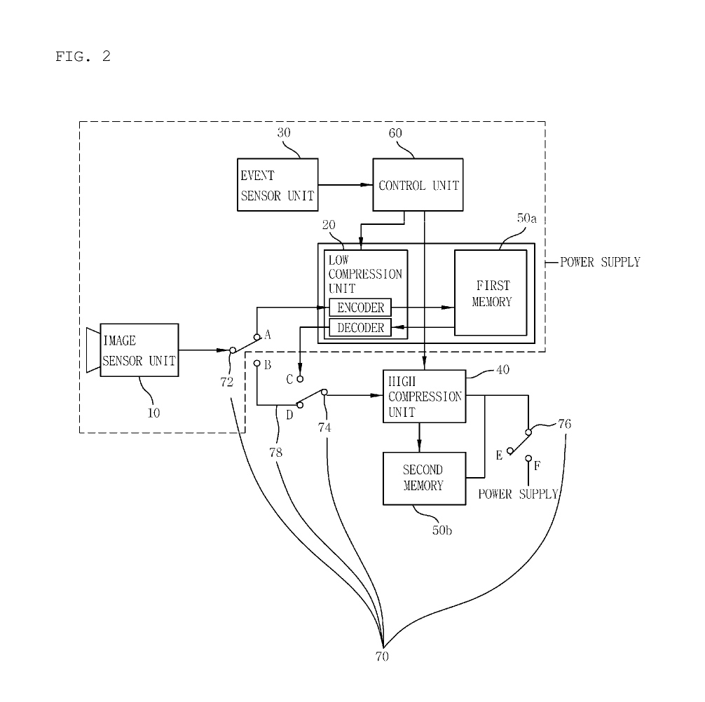

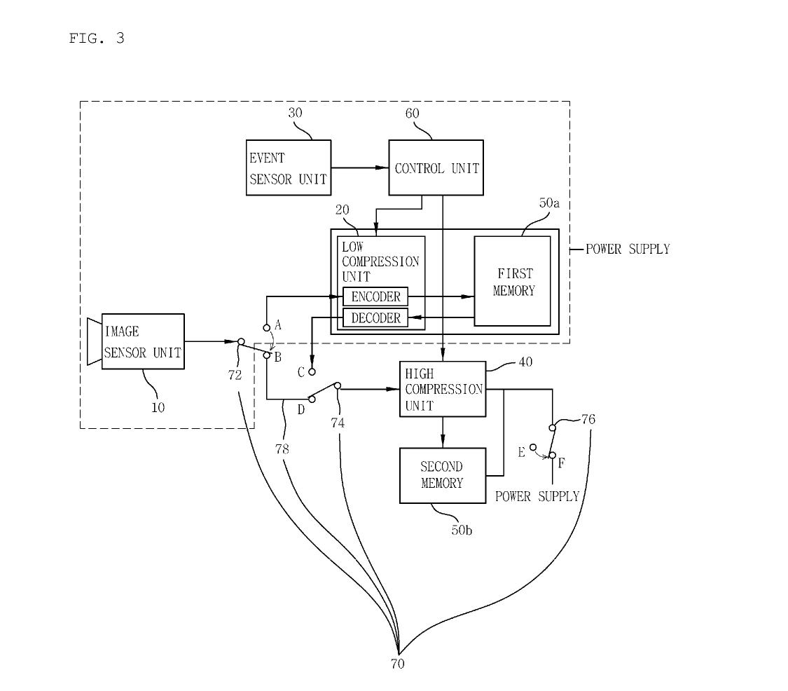

FIG. 2 is a block diagram illustrating an apparatus for monitoring an image with low power according to a first exemplary embodiment of the present invention, FIG. 3 is a block diagram illustrating a state in which a switch unit is connected to a high compression unit after sensing of an event, in the apparatus for monitoring an image with low power according to the first exemplary embodiment of the present invention, and FIG. 4 is a block diagram illustrating a state in which a switch unit connects a low compression unit to the high compression unit after the sensing of the event, in the apparatus for monitoring an image with low power according to the first exemplary embodiment of the present invention.

The apparatus for monitoring an image with low power according to the first exemplary embodiment of the present invention may be configured to include: an image sensor unit 10; a low compression unit 20 encoding image data with a first compression rate; an event sensor unit 30 generating an event signal when an event is sensed; a high compression unit 40 operated by receiving an event signal and encoding the image data of the image sensor unit 10 and the low compression unit 20 with a second compression rate higher than the first compression rate; a memory unit 50 storing the image data encoded by the low compression unit 20 and the high compression unit 40; and a control unit 60 and a switch unit 70 controlling an operation of the image sensor unit 10, the low compression unit 20, the event sensor unit 30, the high compression unit 40, and the memory unit 50. The apparatus for monitoring an image with low power according to the first exemplary embodiment of the present invention has a structure in which the low compression unit 20 and the high compression unit 40 are connected to the image sensor unit 10 in parallel.

The image sensor unit 10 continuously acquires image data and may be configured to include a CMOS image sensor (CIS) and may also be configured in a module type in which an image signal processor (ISP) is included. When the ISP is not included in the image sensor unit 10, the ISP is included in the low compression unit 20 and the high compression unit 40 or is connected to a latter stage of the image sensor unit 10 to transfer the image-processed data to the low compression unit 20 and the high compression unit 40. The image data acquired by the image sensor unit 10 are transferred to the low compression unit 20 or the high compression unit 40.

The low compression unit 20 encodes the image data acquired by the image sensor unit 10 with a first compression rate. Further, the image data encoded with the first compression rate are formed in the same format as one received from the image sensor unit 10 and are decoded to be transferred to the high compression unit 40. The low compression unit 20 encodes the image data with low power and a low compression rate (since the higher the compression rate, the more complicated the compression algorithm becomes, computation and memory usage are increased and thus power consumption is increased) before the event is generated and after the event is generated, the stored image data are decoded or transferred to the high compression unit 40 without being decoded.

The event sensor unit 30 generates an event signal when the event is sensed. The event sensor unit 30 may analyze the image of the image sensor unit 10 to sense the event or may be formed to directly sense the event, separately from the image sensor unit 10.

The high compression unit 40 is operated by directly or indirectly receiving the event signal from the event sensor unit 30 and encodes the image data with the second compression rate higher than the first compression rate. That is, the high compression unit 40 is kept in a low power mode such as idle, sleep, standby, and power-off before the event signal is transferred and is activated in a normal mode after the event signal is transferred. Here, the image data include data acquired by the image sensor unit 10 and data transferred from the low compression unit 20.

When the high compression unit 40 satisfies predetermined conditions while encoding the image data of the low compression unit 20 with the second compression rate, the high compression unit 40 ends the encoding and the low compression unit 20 again encodes the image data acquired by the image sensor unit 10 with the first compression rate. In this case, the predetermined conditions are may be set based on at least one of a predetermined passage of time, presence and absence of motion of an object in the image data transferred to the high compression unit 40, a magnitude of sound captured by an acoustic sensor of the event sensor unit 30, or a magnitude of vibration captured by a vibration sensor, as conditions of determining the event ending. For example, when the high compression unit 40 may end the encoding after 10 seconds, no motion of the object in the image data transferred to the high compression unit 40 is present, and the sound captured by the acoustic sensor is equal to or less than 30 dB (human whispering), the high compression unit 40 may end the encoding.

Generally, the high compression unit 40 stores an image in a frame unit to increase a compression rate, searches for a motion vector in consideration of an inter-frame relation, and utilizes the searched motion vector to perform compression. Unlike this, the low compression unit 20 compresses the image in a line unit (for example, LWC) or a block unit (for example, JPEG), and therefore does not require a large frame memory and a high computing power. An SDRAM used as a frame memory needs to be continuously refreshed and has slightly higher power consumption, and therefore it is preferable for the low compression unit 20 to use a low power DDR (LPDDR) or a flash memory in terms of power efficiency.

For reference, the high compression unit 40 is configured to include an application processor (AP), an internal memory (DDR), and a program ROM (P/G ROM) and stores images to be compared in the internal memory and performs the encoding by the computation of the application processor.

The memory unit 50 stores the image data which are encoded by the low compression unit 20 and the high compression unit 40. The memory unit 50 is configured of a first memory 50a and a second memory 50b and may be formed of a non-volatile storage device such as NAND flash memory.

The first memory 50a which is a component in which the image data encoded by the low compression unit 20 are stored may be embedded in the apparatus for monitoring an image according to the exemplary embodiment of the present invention. As such, the image data stored in the first memory 50a are periodically refreshed for predetermined time. When the first memory 50a is in a full state, the image data within the memory unit 50 are automatically deleted by a control of the control unit 60, such that the image data may be continuously recorded.

The second memory 50b is a component in which the image data encoded by the high compression unit 40 are stored. Meanwhile, inserting and installing the second memory 50b in the apparatus for monitoring an image according to the exemplary embodiment of the present invention as an external type may be advantageous in the movement, utilization and the like of the image data. As the external memory, an MMC type memory card, an SD type memory card, a CF type memory card, and the like may be used.

When the memory unit 50 is configured of the first memory 50a and the second memory 50b, the low compression unit 20 is connected to the first memory 50a and the high compression unit 40 is connected to the second memory 50b. Since a relatively smaller amount of energy is consumed at the time of the data processing by the low compression unit 20, when the available power is limited, the processing of the image data by the low compression unit 20 and the first memory 50a displays a remarkable effect.

For example, in the case in which the apparatus for monitoring an image with low power according to the exemplary embodiment of the present invention is installed in a vehicle, when an engine of the vehicle turns off due to parking, and the like, the apparatus for monitoring an image with low power is supplied with power from a battery installed in the vehicle. In this case, the image data are acquired using the low compression unit 20 and the first memory 50a at ordinary times and when the event signal is generated, the storage of the image data by the high compression unit 40 and the second memory 50b may be performed. Therefore, the low compression unit 20 and first memory 50a are driven with low power at ordinary times and the high compression unit 40 and the second memory 50b are driven only if necessary, such that the power consumption of the apparatus may be generally reduced. On the other hand, when the engine of the vehicle turns on, restrictions on power consumption are relatively reduced, and therefore the image data processing by the low compression unit 20 and the first memory 50a is omitted and the storage of the image data by the high compression unit 40 and the second memory 50b may be performed at all times.

The control unit 60 controls an operation of the image sensor unit 10, the low compression unit 20, the event sensor unit 30, the high compression unit 40, the memory unit 50, and the switch unit 70.

The switch unit 70 is controlled by the control unit 60 and connects among the image sensor unit 10, the low compression unit 20, the high compression unit 40, and a power supply.

The switch unit 70 is configured of a first switch 72, a second switch 74, a third switch 76, and a switching node 78. The first switch 72 selectively switches the connection between the image sensor unit 10 and the low compression unit 20 or the switching node 78, the second switch 74 selectively switches the connection between the high compression unit 40 and the low compression unit 20 or the switching node 78, and the third switch 76 switches the connection between the high compression unit 40 and the power supply. When the low power mode is not power-off but is idle, sleep, and standby, that is, is a mode in which power is not completely cut-off, the third switch 76 is always closed or omitted so as to connect between the high compression unit 40 and the power supply and continuously supplies power to the high compression unit 40.

Therefore, the encoding by the low compression unit 20 is performed by switching the first switch 72 so as to connect the image sensor unit 10 and the low compression unit 20 to each other. Further, the encoding by the high compression unit 40 is performed by switching the third switch 76 so as to connect the high compression unit 40 and the power supply to each other, switching the first switch 72 and the second switch 74 so as to connect the image sensor unit 10, the switching node 78, and the high compression unit 40 to one another, and then switching the second switch 74 so as to connect the low compression unit 20 and the high compression unit 40 to each other.

The first switch 72 and the third switch 76 may be operated by interlocking with each other. In this case, the operation of the low compression unit 20 and the high compression unit 40 is selectively performed, and therefore the power consumption may be effectively reduced.

The switches included in the switch unit 70 may be formed of an electronic switch such as transistor.

According to the apparatus for monitoring an image with low power according to the first exemplary embodiment of the present invention, a switching process of the switch unit 70 is as follows.

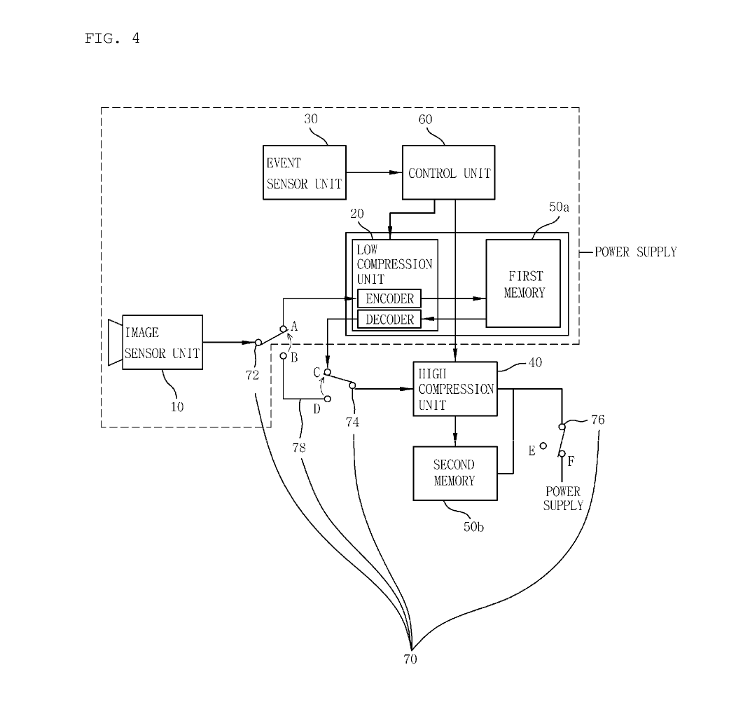

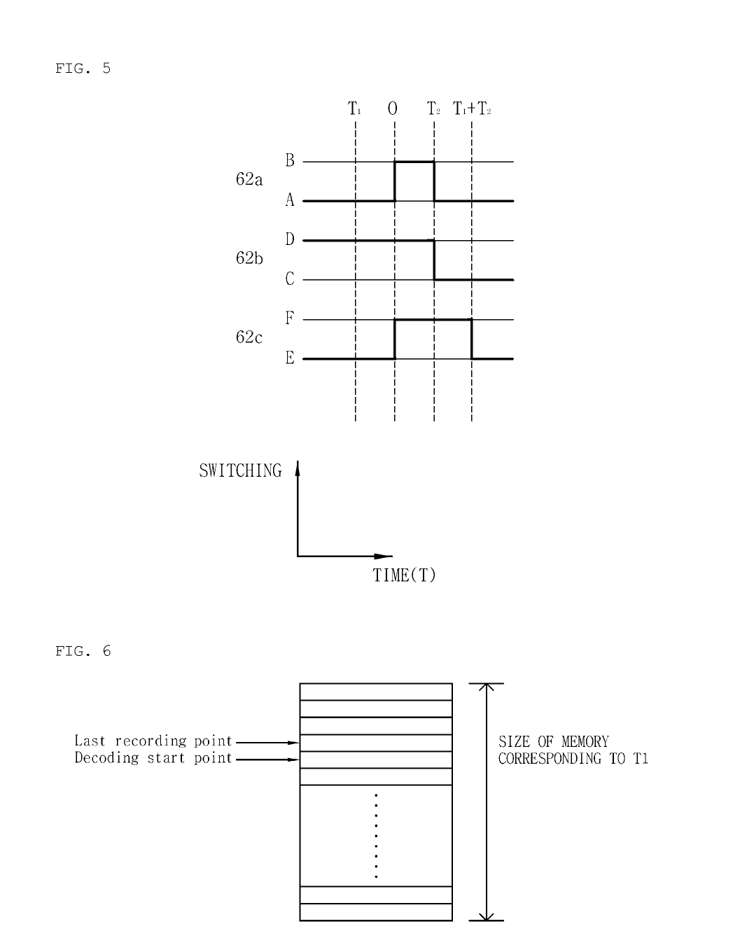

FIG. 5 is a signal diagram illustrating a switching process of the switch unit, in the apparatus for monitoring an image with low power according to the first exemplary embodiment of the present invention and FIG. 6 is a configuration diagram illustrating a logical configuration of a first memory according to an exemplary embodiment of the present invention. The first memory illustrated in FIG. 6 needs to have capacity in which the image data may be encoded and stored with the low compression rate for at least T₁, in which newly stored data are stored, overlapping with each other from old data. Referring to FIG. 6, the oldest data just after a last recording point are stored and new image data are sequentially stored just after the last recording point. Therefore, although described below, after the sensing of the event, the image data which are transferred from the low compression unit to the high compression unit become data from just after the last recording point to an end of the memory and from the first of the memory to the last recording point (the reason is that a point just after the last recording point becomes a decoding start point).

1) Before Sensing of Event

The switching of the switch unit 70 which connects the first switch 72 to position A, the second switch 74 to position D, and the third switch 76 to position E is made. In this state, the image data are transferred to the low compression unit 20 connected to the image sensor unit 10 to perform the encoding and the encoded image data are stored in the first memory 50a (FIG. 2).

In this case, the connection between the image sensor unit 10 and the high compression unit 40 is cut off and thus the unnecessary power consumption while encoding and storing the image data acquired at all times before the sensing of the event may be reduced.

2) After Sensing of Event

The switching of the switch unit 70 which connects the first switch 72 to position B and the third switch 76 to position F is made (FIG. 3). Therefore, the low compression unit 20 stores the last recording point while stopping the encoding operation, the high compression unit 40 encodes the image data input from the image sensor unit 10 while being connected to the image sensor unit 10, and the encoded result is stored in the second memory 50b.

Next, the switching of the switch unit 70 which connects the second switch 74 to position C is made and transfers the image data of the first memory 50a of the low compression unit 20 to the high compression unit 40 (FIG. 4). The image data transferred from the low compression unit 20 to the high compression unit 40 may be original image data acquired by decoding the image data encoded by the low compression unit 20 or data acquired by reading the low-compressed image data without being decoded. In the case of the decoding, the image data are transferred to the high compression unit 40 in the same format as one received by the image sensor unit 10 at the time of the encoding operation by performing a decompression from the decoding start point finally stored in the first memory 50a to the last recording point and in the case of the reading, the encoded image data are transferred to the high compression unit 40 from the decoding start point finally stored in the first memory 50a to the last recording point. When the transfer of the image data from the low compression unit 20 to the high compression unit 40 is completed, the switching of the switch unit 70 which again connects the first switch 72 to position A, the second switch 74 to position D, and the third switch 76 to position E is made, and thus the encoded image data return to the state before the sensing of the event.

The image data transferred to the high compression unit 40 in the state of FIG. 4 is annexed before the image data encoded by the high compression unit 40 in the state of FIG. 3. Since the image data transferred to the high compression unit 40 in the state of FIG. 4 is the image data before the sensing of the event, it precedes the image data encoded by the high compression unit 40 in the state of FIG. 3.

An overall operation of the apparatus for monitoring an image with low power according to the first exemplary embodiment of the present invention is as follows.

FIG. 7 is a flow chart illustrating an operating process of the apparatus for monitoring an image with low power according to the first exemplary embodiment of the present invention.

The low compression unit encodes the image data with the first compression rate and stores the encoded image data in the first memory to sense whether the event is generated while the high compression unit keeps a low power mode (S10); and when the event sensor unit is operated (S20) to generate the event signal (S30), the high compression unit is activated by the event signal (S50) to encode the image data transferred to the high compression unit with the second compression rate higher than the first compression rate and store the encoded image data in the second memory (S60). When the image sensor unit 10, the low compression unit 20, and the high compression unit 40 are connected to one another by the switch unit 70, the activation of the high compression unit 40 is made according to the switching of the switch unit 70 (S40).

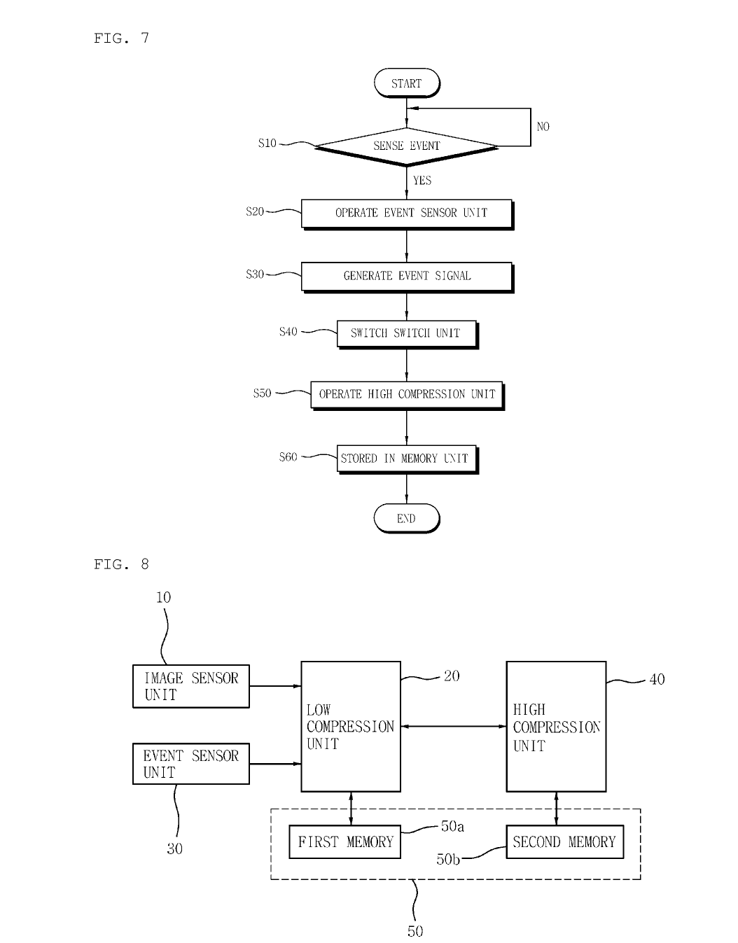

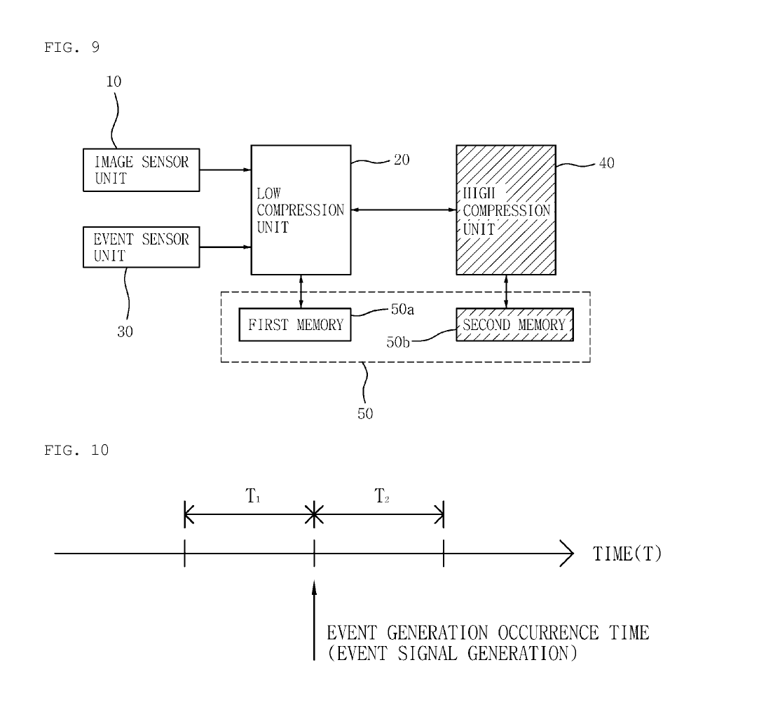

FIG. 8 is a diagram illustrating an apparatus for monitoring an image with low power according to a second exemplary embodiment of the present invention and FIG. 9 is a reference diagram for describing a low power mode of the apparatus for monitoring an image with low power according to the second exemplary embodiment of the present invention.

The apparatus for monitoring an image with low power according to the second exemplary embodiment of the present invention is configured to include: the image sensor unit 10: the low compression unit 20 encoding the image data with the first compression rate; the event generation unit generating the event signal when the event is sensed; the high compression unit 40 operated by receiving the event signal and connected to the low compression unit 20 in series to encode the image data of the image sensor unit 10 and the low compression unit 20 with the second compression rate higher than the first compression rate; and the memory unit 50 storing the image data encoded by the low compression unit 20 and the high compression unit 40. The apparatus for monitoring an image with low power according to the second exemplary embodiment of the present invention has a structure in which the low compression unit 20 and the high compression unit 40 are connected to the image sensor unit 10 in series.

The second exemplary embodiment that the low compression unit 20 encodes the image data with the first compression rate before the sensing of the event and the high compression unit 40 is kept at the low power mode (illustrated by hatching in FIG. 9) is the same as the first exemplary embodiment. However, in the case of the second exemplary embodiment, since the image sensor unit 10, the low compression unit 20, and the high compression unit 40 are connected to one another in series, the operation after the sensing of the event may be largely implemented in two types.

First, after the sensing of the event, the image data acquired by the image sensor unit 10 may bypass the low compression unit 20 and may be transferred to the high compression unit 40. That is, after the sensing of the event, the image data acquired by the image sensor unit 10 is encoded with the second compression rate by the high compression unit 40, while the image data preceding the sensing of the event is annexed before the image data that is transferred from the low compression unit 20 and encoded by the high compression unit 40. Therefore, the first type according to the second exemplary embodiment is substantially the same as the technical spirit of the first exemplary embodiment.

Second, after the sensing of the event, the image data acquired by the image sensor unit 10 are processed by the low compression unit 20 until the event ends and when the event ends, both of the image data before the sensing of the event and the image data after the sensing of the event may be transferred to the high compression unit 40. The image data transferred from the low compression unit 20 to the high compression unit 40 may be the original image data acquired by decoding the image data encoded by the low compression unit 20 or the image data read without being decoded. In the second type, the image data before the sensing of the event are included in the image data transferred from the low compression unit 20 to the high compression unit 40 in advance, and therefore similar to the first type, the image data before the sensing of the event in the high compression unit 40 are received from the low compression unit 20 and therefore need not to be annexed to the image data encoded by the high compression unit 40. Therefore, since the second type has a simple configuration but power consumption due to the encoding of the image data after the sensing of the event by the low compression unit 20, it is determined whether the first type is selected or the second type is selected in consideration of the overall efficiency of the apparatus.

FIG. 10 is a relationship diagram between the apparatus for monitoring an image with low power according to the exemplary embodiment of the present invention and before and after the occurrence of the event. According to the first and second exemplary embodiments of the present invention, the image data stored in the second memory unit 50b are data acquired by encoding the image data before and after (T₁ and T₂) of the generation of the event signal with the high compression rate. Further, in the case of the first type according to the first and second exemplary embodiments of the present invention, the high compression unit 40 becomes a normal mode at the time of the occurrence of the event and is normally operated (encoded) for T₂ and then again returns to the low power mode and in the case of the second type according to the second exemplary embodiment of the present invention, the image data are encoded with the low compression rate by the low compression unit 20 before and after (T₁ and T₂) the generation of the event signal and then transferred to the high compression unit 40.

According to the exemplary embodiments of the present invention, the apparatus for monitoring an image with low power may be continuously operated with low power before the occurrence of the event and may acquire the image data before the occurrence of the event in the low power state to reduce the power consumption.

Further, it is possible to increase the storage efficiency of data by encoding the image data using the algorithm having excellent compression rate at the time of the event occurrence.

What is claimed is:

1. An apparatus for monitoring an image with low power, the apparatus comprising:
an image sensor unit;
a low compression unit encoding image data acquired by the image sensor unit with a first compression rate;
an event sensor unit generating an event signal when an event is sensed;
a high compression unit operated by receiving the event signal and encoding the image data of the image sensor unit and the low compression unit with a second compression rate higher than the first compression rate; and
a memory unit storing the image data encoded by the low compression unit and the high compression unit.

2. The apparatus of claim 1, wherein the high compression unit encodes the image data acquired by the image sensor unit and the image data decoded by the low compression unit.

3. The apparatus of claim 1, further comprising:
a switch unit controlling a connecting among the image sensor unit, the low compression unit, the high compression unit, and a power supply.

4. The apparatus of claim 3, wherein the switch unit includes:
a switching node;
a first switch selectively switching a connection between the image sensor unit and the low compression unit or the switching node;
a second switch selectively switching a connection between the high compression unit and the low compression unit or the switching node; and
a third switch switching between the high compression unit and the power supply.

5. The apparatus of claim 4, wherein the encoding by the low compression unit is performed by switching the first switch to connect the image sensor unit to the low compression unit, and
the encoding by the high compression unit is performed by switching the third switch to connect the high compression unit to the power supply, switching the first switch and the second switch to connect among the image sensor unit, the switching node, and the high compression unit, and then switching the second switch to connect the low compression unit to the high compression unit.

6. The apparatus of claim 4, wherein the first switch and the third switch are operated by interlocking with each other.

7. The apparatus of claim 1, wherein the memory unit includes:
an internal first memory in which the image data encoded by the low compression unit are stored; and
an external second memory in which the image data encoded by the high compression unit are stored.

8. The apparatus of claim 7, wherein the image data stored in the first memory are periodically refreshed for a predetermined time.

9. The apparatus of claim 7, wherein the apparatus for monitoring an image with low power is installed in a vehicle and when an engine of the vehicle turns off, the image data encoded by the low compression unit are stored in the first memory.

10. The apparatus of claim 7, wherein the image data stored in the second memory are configured of image data before the event signal stored in the first memory is generated and image data after the event signal transferred from the image sensor unit is generated.

11. The apparatus of claim 1, wherein in the case in which the event signal is transferred, when the high compression unit satisfies predetermined conditions while encoding the image data transferred from the image sensor unit with the second compression rate, the encoding ends, and
the image data before the sensing of the event transferred from the low compression unit are encoded with the second compression rate and are annexed to image data encoded after the sensing of the event.

12. The apparatus of claim 11, wherein the predetermined conditions are set based on at least one of a predetermined passage of time, presence and absence of motion of an object in the image data transferred to the high compression unit, a magnitude of sound or a magnitude of vibration sensed by the event sensor unit, as conditions of determining the event ending.

13. An apparatus for monitoring an image with low power, the apparatus comprising:
an image sensor unit;
a low compression unit consuming low power by compressing image data acquired by the image sensor unit with relatively low efficiency; and
a high compression unit consuming high power by compressing the image data acquired by the image sensor unit with relatively high efficiency,
wherein when an event is not sensed, the image data acquired by the image sensor unit are encoded by the low compression unit and the high compression unit is kept at a low power mode.

14. The apparatus of claim 13, wherein when the event is sensed, the high compression unit is activated at a normal mode in the low power mode.

15. The apparatus of claim 13, wherein when the event is sensed, the image data encoded by the low compression unit are transferred to the high compression unit.
